(19) United States
(12) Patent Application Publication
(10) Pub. No.: US 2010/0304321 A1
(43) Pub. Date: Dec. 2, 2010

(54) FIVE SEGMENT ORTHODONTIC ARCH WIRE AND ORTHODONTIC APPARATUS MADE THEREOF

(76) Inventor: Vishnu Jagdishbhai Patel, Ahmedabad (IN)

Correspondence Address: THE PATEL LAW FIRM, P.C., 2532 DUPONT DRIVE, IRVINE, CA, 92612, US

(21) Appl. No.: 12/739,140

(22) PCT Filed: Apr. 10, 2008
(86) PCT No.: PCT/IN08/00238

§ 371 Date: Apr. 21, 2010

(30) Foreign Application Priority Data
Dec. 17, 2007 (IN) 2468/MUM/2007

(51) Int. Cl. A61C 7/20; A61C 7/28; A61C 7/16

(52) U.S. Cl. 433/9; 433/20; 433/10

(57) ABSTRACT

The present invention relates to an arch wire that is used during orthodontic treatment. In accordance to the present invention a five segment orthodontic arch wire to provide a track for movement of teeth for correcting misalignment of teeth, said arch wire generally having ‘U’ shape and having same longitudinal axis through out the length, said arch wire characterized by: first segment having rectangular cross section and being provided for the posterior, 2nd premolar and molar region in left side of the jaw; second segment having rectangular cross section with rounded off corners, said second segment is followed by said first segment and provided for the canine and first premolar region in left side of the jaw; third segment having rectangular cross section, said third segment is followed by said second segment and provided for the anterior, incisor region; fourth segment having rectangular cross section with rounded off corners, said fourth segment is followed by said third segment and provided for the canine and 1st premolar region in right side of the jaw; and fifth segment having rectangular cross section, said fifth segment is followed by said fourth segment and provided for the posterior, 2nd premolar and molar region in right side of the jaw, wherein said arch wire is single piece and continuous in construction. Also an orthodontic apparatus comprising a five segment orthodontic arch wire in accordance with the present invention along with slotted bracket is also provided.

### FIELD OF THE INVENTION

The present invention relates to an arch wire that is used during orthodontic treatment. More particularly, the present invention relates to a continuous orthodontic arch wire with variable cross-sectional shape and size that is applied according to the anchorage requirement. It further relates to an orthodontic apparatus comprising such arch wire.

### BACKGROUND OF THE INVENTION

Orthodontics is a specialized dental practice concerned with the movement of teeth to achieve an effective occlusion, and to provide a pleasing facial contour and appearance of the teeth. Canine retraction is an important biomechanical task in orthodontic treatment. A canine, being the corner stone of the dental arches needs to be placed in a position of stability to fulfill its role in functional occlusion. The biomechanics involved in canine retraction are either sliding mechanics or frictionless mechanics. Sliding mechanics is preferred over frictionless mechanics because there are many disadvantages of frictionless mechanics that uses closing loop arch wires. The disadvantages associated with frictionless mechanics are as follow:
1. It requires high skills which is required for tedious wire bending.
2. It has limited range of action.
3. It requires extra tip and rotation control by putting extra bends.
4. It provides poor 3D control between anchor segment and retraction segment.

Mainly there are two types of conventional bracket-wire configurations the first one in which the arch wire is held with the help of either ligature wire or elastic module and the other one is self-ligating bracket in which clip of the bracket holds the wire in the bracket slots. There are mainly two conventional slots, which are widely used are 018 and 022 slots.

In conventional sliding mechanics, rectangular or circular or trapezoidal stainless steel wire of universal cross-sectional form is used, which has same cross-sectional shape and dimension throughout its entire length. Generally, configuration of these conventional wires are of 16×22 mil in 018 slot & 19×25 mil in 022 slot in ordinary cases. However, larger dimension wires like 17×22 mil or 17×25 mil in 018 slot and 20×25 mil or 21×25 mil wire in 022 slot are also used.

In order to achieve an effective occlusion and to provide a pleasing facial contour and appearance of teeth, proper orthodontic treatment is necessary. The orthodontic treatment for extraction cases mainly includes the following steps:
i. extraction of 1^{st} premolar in order to make enough room for the remaining teeth,
ii. fixing of orthodontic appliance comprising brackets and archwire on the teeth,
iii. bracket slot line up to 16×22 mil stainless steel wire in 018 slot & 19×25 mil stainless steel wire in 022 slot
iv. canine retraction followed by the anchoraging as per the need of the patient;
v. retraction of four incisors by force acting from consolidated canine, 2^{nd} premolar and molars; and finally
vi. finishing and detailing of occlusion.

For canine retraction 120-140 gm of force is required on either side; but additional 100-125 gm force is required to overcome frictional resistance for initiating tooth movement, so almost double force has to be applied for canine retraction. Accordingly double reactive force is felt on the anchorage unit according to Newton's 3^{rd} law of motion.

Hence, the major drawbacks associated while using the conventional arch wire used in canine retraction are:

1. It involves heavy force,
2. It can place considerable load on anchorage unit,
3. It can cause anchorage burn-out.

In order to achieve desired results, the wire should not slide through anchorage unit brackets and at the same time there should be enough clearance for sliding of canine bracket along the arch wire.

The best canine retraction suggested, in terms of time, biologic health and anchorage preservation involves:
1. Optimal Force,
2. Minimum tissue damage,
3. Minimum or no anchorage loss.

In order to achieve aforementioned canine retraction characteristics and to overcome the deficiencies associated with conventional arch wire, there is need to provide an improved arch wire which will provide the best results in orthodontic treatment.

### OBJECTS OF THE INVENTION

Therefore, the primary object of the present invention is to provide orthodontic arch wire to fulfill above mentioned canine retraction requirements and to obviate drawbacks of conventional arch wire.

Another object of the invention is to provide an orthodontic wire, which avoids sliding of arch wire through posterior anchorage unit brackets, and provides enough clearance for canine sliding with minimum possible frictional resistance.

Yet another object of the invention is to provide an orthodontic arch wire which provides better orthodontic treatment result as the anchorage is well maintained, so in high anchorage cases (majority of 1^{st} premolar extraction cases), mainly in upper arch the extraction space is mostly utilized in canine retraction followed by four incisor retraction.

Further object of the invention is to provide an orthodontic arch wire, by which undermined resorption and hyalinization is minimized as Biological friendly forces are used.

Further object of the invention is to provide an orthodontic arch wire, which reduces the cost of overall orthodontic treatment.

Further object of the invention is to provide an orthodontic arch wire, which also reduces the duration of treatment.

Further object of the invention is to provide an orthodontic arch wire, in which various rounding edge radius and arch wire dimension combinations are used according to anchorage requirement to achieve best possible clinical outcome at comparable lower cost.

### SUMMARY OF THE INVENTION

Accordingly to achieve the aforesaid objects, present invention provides a five segment orthodontic arch wire to provide a track for movement of teeth for correcting misalignment of teeth, said arch wire generally having “U’ shape and having same longitudinal axis through out the length, said arch wire characterized by: first segment having rectangular cross section and being provided for the posterior, 2^{nd} premolar and molar region in left side of the jaw;

second segment having modified rectangular cross section with rounded off corners, said second segment is followed by said first segment and provided for the canine and first premolar region in left side of the jaw;

third segment having rectangular cross section, said third segment is followed by said second segment and provided for the anterior, incisor region;

fourth segment having modified rectangular cross section with rounded off corners, said fourth segment is followed by said third segment and provided for the canine and 1^{st} premolar region in right side of the jaw; and

fifth segment having rectangular cross section, said fifth segment is followed by said fourth segment and provided for the posterior, 2^{nd} premolar and molar region in right side of the jaw,

wherein said arch wire is single piece and continuous in construction.

According to another embodiment of the present invention the corners of the second and fourth segments of said arch wire are rounded off with circular arc centered at the center of the rectangle and having same or different radius of curvature at all corners.

According to another embodiment of the present invention the corners of the second and fourth segments of said arch wire are rounded off with circular arc centered at the center of the rectangle and with radius of curvature varying in the range of about 0.25 mm to 0.40 mm. The radius of curvature is preferably in the range of about 0.28 mm to 0.336 mm being applicable for the arch wires in 018 slot and about 0.32 mm to 0.365 mm being applicable for the arch wires in 022 slot.

According to one of the embodiment of the present invention, the arch wire is made of stainless steel, super elastic nickel-titanium, tooth colored Teflon coated wire, Titanium Molybdenum Alloy or any like material.

Also an orthodontic apparatus for correcting misalignment of the teeth comprising a five segment orthodontic arch wire in accordance with the present invention along with slotted bracket is also provided.

### BRIEF DESCRIPTION OF THE DRAWINGS

FIG. 1: shows the plan view of the orthodontic arch wire in accordance with the present invention.

FIG. 2: shows the cross-sectional view of the conventional Rectangular arch wire.

FIGS. 3A-3C: shows the various cross-sectional views of the segments of arch wire of the present invention having modified rectangular cross section with rounded off corners having different radius of curvature R.

FIG. 4: shows cross-sectional view of conventional rectangular 19×25 mil (0.48×0.64 mm) wire fully engaged in 022 slot.

FIGS. 5A-5C: shows cross sectional views of the segments of the arch wires shown in FIGS. 3A-3C with fully engaged in 022 slot.

FIG. 6: shows cross sectional view of the wire section shown in FIG. 4 in twisted form.

FIGS. 7A-7C: shows cross sectional views of wire sections shown in FIGS. 5A-5C in twisted form.

FIG. 8: shows orthodontic apparatus in accordance with the present invention fitted over the teeth.

### DETAILED DESCRIPTION OF THE INVENTION

The above, and the other objects, features & advantages of invention will become apparent from following description read in conjunction with the accompanying drawings.

It is known that canine retraction is an important biomechanical task in orthodontic treatment. Hence canine and first premolar region cannot be treated same as that of others. Accordingly, present invention herein proposes an improved arch wire, which deals with each of the regions of the tooth line as per its requirement.

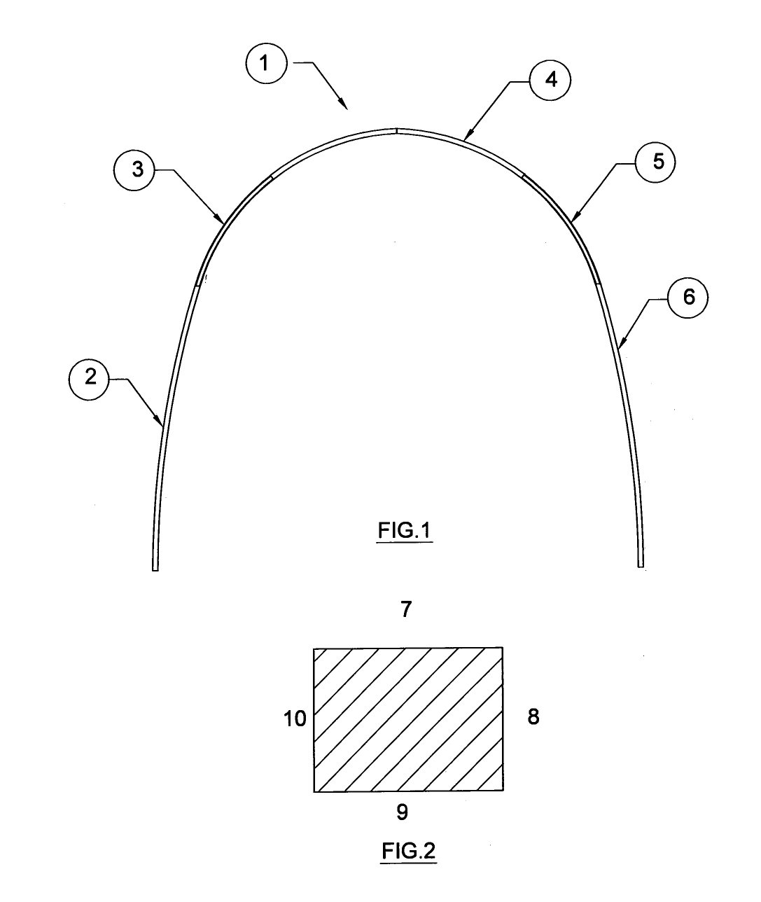

Therefore, in accordance with the present invention, as shown in FIG. 1, a new and improved orthodontic arch wire (1) is introduced that is segmented in five portions (2), (3), (4), (5) and (6), which is applied as per the anchorage requirement, wherein arch wire portions (2), (4) and (6) are having rectangular cross-section and arch wire portions (3) and (5) are having modified rectangular cross section with rounded off corners.

The orthodontic arch wire (1) is generally of U shape and having same longitudinal axis throughout its length. The arch wire (1) is a continuous wire with variable cross sectional shape and size that is applied according to the anchorage requirement.

The present invention proposes that arch wire portion (2) with rectangular cross-section is to be applied in posterior 2^{nd} premolar and molar region in the left side of the jaw; arch wire portion (3) with modified rectangular cross-section in intermediate canine and first premolar region in the left side of the jaw; arch wire portion (4) with rectangular cross-section in anterior incisor region; arch wire portion (5) with modified rectangular cross-section in the intermediate canine and 1^{st} premolar region in right side of the jaw; and finally, arch wire portion (6) with rectangular cross-section in posterior 2^{nd} premolar and molar region in the right side of the jaw. As mentioned earlier, the corners of the arch wire portions (3) and (5) are rounded off throughout their cross section with different values of radius R, where radius of the circle should be selected as an effective compromise between torque expression requirement and reduction in frictional resistance and in turn anchorage requirement. Such radius varies preferably in the range of about 0.25 mm to 0.40 mm and more preferably in the range of about 0.28 mm to 0.336 mm for the wires used in 018 slot and 0.32 mm to 0.365 mm for the wires used in 022 slot.

Referring to FIG. 2, which shows cross section of conventional rectangular arch wire. It comprises of four flat sides (7), (8), (9) and (10). The cross sectional shape and dimension of arch wire is substantially uniform along its entire length. This configuration applies to portions (2), (4) and (6) of the arch wire of the present invention.

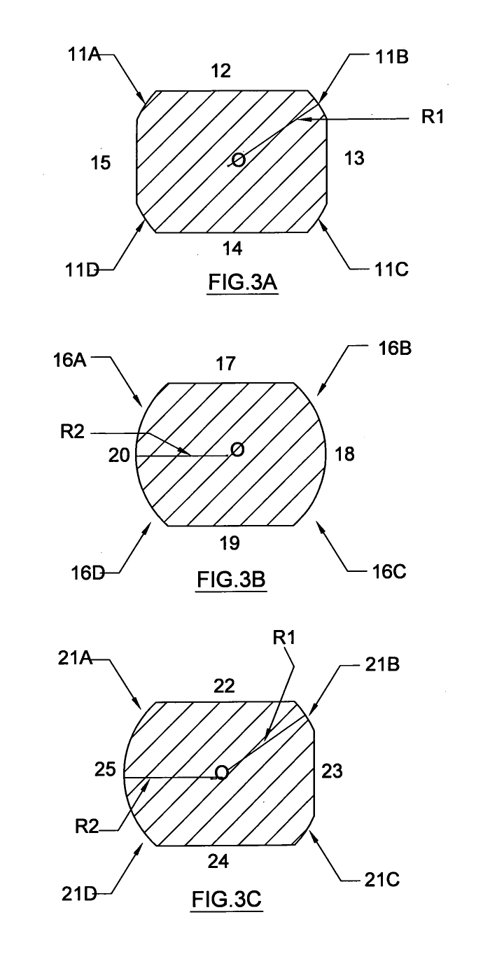

FIGS. 3A-3C shows cross-sectional view of arch wire portions (3) and (5), which are having modified rectangular cross section with rounded off corners.

As shown in FIG. 3A, the rounded off corners have circular arc 11A, 11B, 11C and 11D, centered at the center of the rectangle O with radius of curvature R=R1 (maximum radius value for the particular wire). Said modified rounded off wire further comprises of four flat sides 12, 13, 14 and 15.

As shown in FIG. 3B cross sectional view of wire portions (3) and (5) wherein corners of rectangular wire are rounded off at all four corners with circular arc 16A, 16B, 16C and 16D, centered at the center of the rectangle O with radius of the curvature R=R₂ (minimum radius value for the particular wire). Said modified rounded off wire further comprises of four flat sides 17, 18, 19 and 20.

Optionally, the radius of curvature of all four of the rounded corners is same. However, asymmetric construction is also possible, wherein the corners of the arch wire can be asymmetrically rounded off through out portion (3) and (5) to achieve desired results. Preferably, on inner slot base facing side, radius of curvature used is smaller than the outer facial side, where it is larger one.

Accordingly, FIG. 3C shows said possible construction of modified rounded off arch wire portions (3) and (5). FIG. 3C shows cross-sectional view of modified rounded off arch wire with asymmetric radius and accordingly asymmetric arch, where each circular arch is centered at the center of the rectangle O. Said wire comprises of four flat sides 22, 23, 24, 25 and circular arc 21A, 21B, 21C, 21D. Said circular arc 21A, 21D are having radius R₂ and 21B, 21C are having radius R₁, where and R₁>R₂.

As known, the frictional resistance is directly proportional to the surface area contact. With this proposed modification in arch wire, surface area contact is reduced considerably; thereby-reducing frictional resistance. It is further explained by making a comparative study between wires of different flat wire dimension, as shown in FIG. 2 and FIGS. 3A-3C, which shows advantage of this modified rounded off wire over conventional rectangular wire in reducing surface area contact with the bracket slot walls. It illustrates that conventional rectangular wire portions (2) or (4) or (6) represented by wire portion A₁, is having more surface area contact than the modified rounded off wire portions (3) or (5) represented by wire B₁, C₁ and D₁, wherein wire B₁, C₁ and D₁, are having different values for radius of curvature. The comparison is made in following Table 1 for the wire 19×25 mil engaged in 022 slot:

TABLE 1

| | | | | | Total linear |
|---|---|---|---|---|---|
| | | | | Linear | surface |
| | | | | surface | contact per |
| | | Radius of | Surface | contact | cross-section |
| Wire | FIG. | curvature | in contact | (mm) | (mm) |
| A₁ | 2 | N/A | 10 | 0.48 | 1.60 |
| | | | 7 | 0.64 | |
| | | | 8 | 0.48 | |
| B₁ | 3 A | R₁ = 0.35 mm | 15 | 0.284 | 1.314 |
| | | | 12 | 0.51 | |
| | | | 11B | 0.118 | |
| | | | 13 | 0.284 | |
| | | | 11C | 0.118 | |
| C₁ | 3 B | R₂ = 0.32 mm | 20 | 0.02 | 0.995 |
| | | | 17 | 0.423 | |
| | | | 16B | 0.266 | |
| | | | 18 | 0.02 | |
| | | | 16C | 0.266 | |
| D₁ | 3 C | R₂ = 0.32 mm | 25 | 0.02 | 1.006 |
| | | R₁ = 0.35 mm | 22 | 0.466 | |
| | | | 21B | 0.118 | |
| | | | 23 | 0.284 | |
| | | | 21C | 0.118 | |

Advantages of modified rounded off wire also applicable in the arch wire having dimension 16×22 mm in 018 slot.

Thus the proposed modified rounded off wire has less surface contact than the conventional one and this surface can be further reduced by reducing the radius value of respective circular arch. Hence when rounded off cross-section arch wires are used in crucial positions like canine and first premolar regions, they offer reduced frictional resistance and thereby effective result. In the same wire, cross-section at 2^{nd} premolar and molar region is rectangular, so the force applied can be selected as to retract canine rapidly and effectively with minimum or no anchorage loss. (Mesial movement of 2^{nd} premolar and molar along arch wire by sliding) Thus with differential friction mechanics, better clinical outcome can be achieved.

FIG. 4 shows the rectangular cross sectional segment of the arch wire fitted in the slot (32) of the bracket (31).

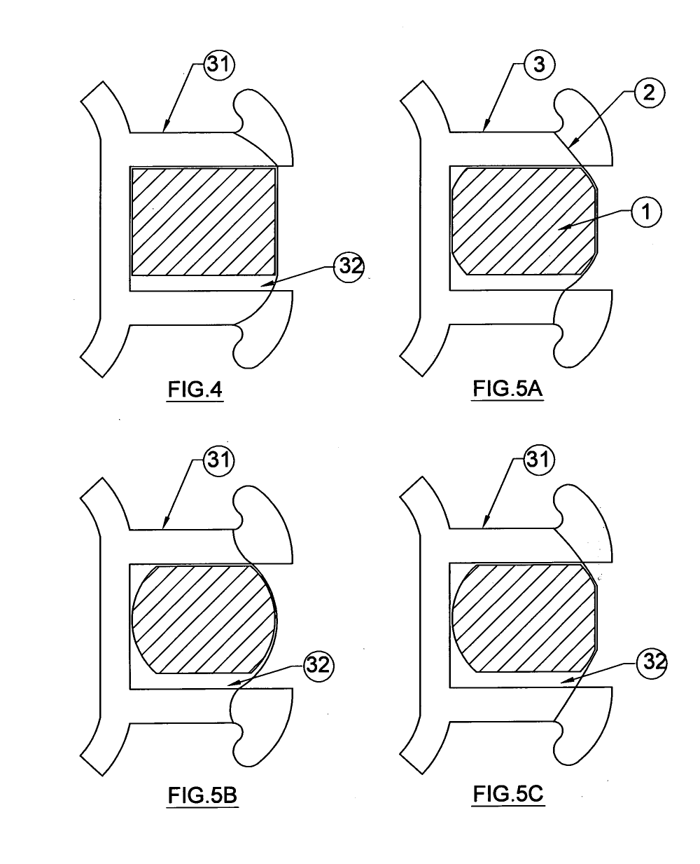

FIGS. 5A-5C show cross sectional views of the segments of the arch wires shown in FIGS. 3A-3C with fully engaged in 022 slot

FIG. 6 shows cross sectional view of the wire section shown in FIG. 4 in twisted form.

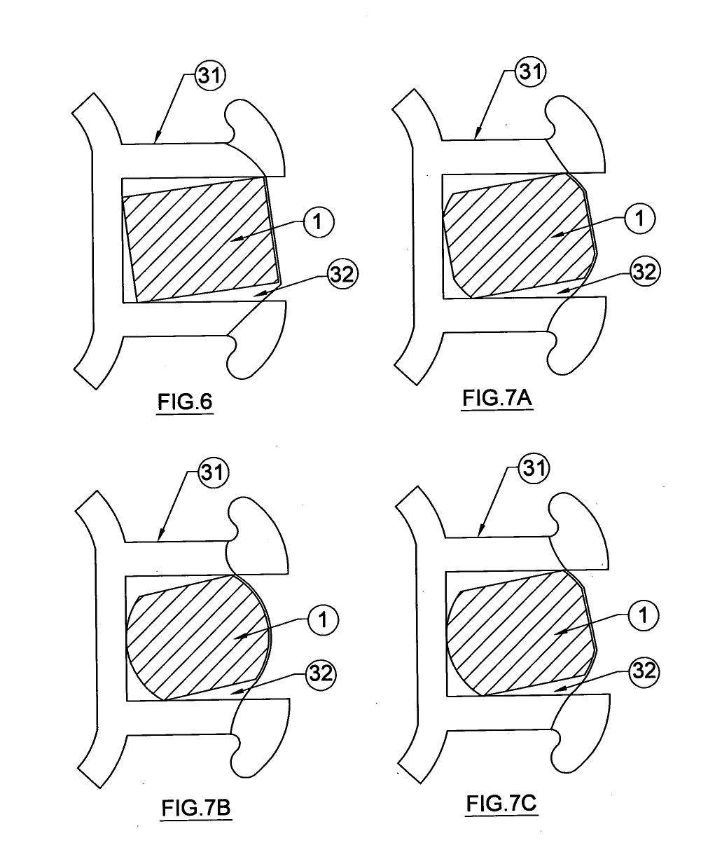

FIG. 7A-7C shows cross sectional views of wire sections shown in FIGS. 5A-5C in twisted form.

When the wire is twisted in the bracket slot thus results torque expression, the degree of play is less and moment arm length is more of the wire portions (2), (4) and (6) than those of the wire portions (3) and (5). Accordingly more torque is expressed in posterior anchorage region and anterior incisor region, in relation to the intermediate canine and 1^{st} premolar regions. So these wire portions become passive in the slot earlier than the anchorage unit and incisor region. More passive the wire engaged in slot, friction is less and vice a versa.

Referring to FIGS. 4, 5A-5C, 6 AND 7A-7C, it becomes clear how the proposed modified arch wire is advantageous over conventional rectangular wire in reducing binding tendency and surface contact between the canine bracket slot walls and the arch wire; accordingly reducing frictional resistance, with little reduction in torque control as described below. When wire A2, B2, C2 and D2 as shown in FIGS. 6 AND 7A-7C respectively are twisted in the bracket slot, then their degree of play and moment arm for torque expression will be as described in following Table 2. (19×25 mil engaged in 022 slot)

TABLE 2

| | | Cross-section | Degree of | Moment |
|---|---|---|---|---|
| Wire | FIG. | (mm) | play | arm (mm) |
| A₂ | 6 | 0.48 × 0.64 | 7.557° | 0.571 |
| B₂ | 7A | 0.284 × 0.51 | 9.838° | 0.42 |
| C₂ | 7B | 0.02 × 0.423 | 12.455° | 0.31 |
| D₂ | 7C | | 10.972° | 0.367 |

The amount of torque actually expressed by a bracket is highly dependent upon wire choice. Rounded off arch wires, generate very low torque. Rectangular or square wires which are large or small relative to the bracket slot will generate more or less actual torque, respectively, due to a lessening or increase of the wire-to-slot deviation angle—referred to as slot “play.” Greater degree of play in the bracket slot leads to a lower torque value, while less play leads to a higher torque value. In other words less the degree of play, longer the moment arm, so more torque expression and vice versa. Although torque expression at canine bracket is reduced with these modified wires, it is either negligible or beneficial, for maintaining canine root in highly vascular spongy bone for faster and healthy movement for most of the cases.

There are mainly two standard slots with sizes 018 and 022 mil in which the arch wire is to be placed. In ordinary cases, standard dimension wires like 16×22 mil in 018 slot and 19×25 mil in 022 slot are used. However, larger dimension wire like 17×22 mil or 17×25 mil in 018 slot and 20×25 mil or 21×25 mil wire in 022 slot can also be used.

Whenever said larger dimension wire is used, first, the dimension of the wire at canine and 1^{st} premolar region is reduced to the standard one for effective sliding and then it is rounded off in the said region. Hence, irrespective of the wire dimension in incisor region and posterior anchorage segment, the shape and size of wire cross-section in canine and 1^{st} premolar region should be as in standard dimension wires in their respective slots.

In critical situations, the same larger size wire is directly rounded off with respective radius in canine and 1^{st} premolar region. Larger dimension wires are used only in extra critical anchorage situations. In extra critical anchorage situation, if larger dimension wire is used, wire sliding through anchor segment is reduced considerably by increasing arch wire dimension in anchor segment, thus anchor loss is prevented.

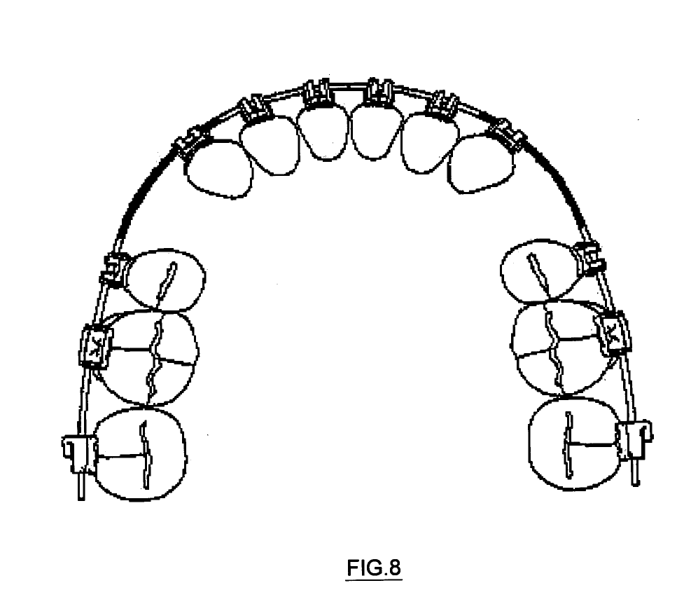

Now referring to FIG. 8, which shows orthodontic apparatus (41) fitted over teeth of the patient. The orthodontic apparatus comprises an arch wire (1) manufactured in accordance with the present invention. Further it comprises the plurality of brackets (31) with slots (32) for coupling said arch wire (1) to the teeth. The slots have shape and size as per the shape and size of portions (2, 3, 4, 5, 6) of the arch wire so that arch wire is properly fitted in said bracket slots. The arch wire (1) is coupled to teeth by slotted bracket (31) secured to teeth either by direct adhesive attachment or by being fastened to a tooth band fitted over and cemented to teeth.

Advantages of the Arch Wire of the Present Invention

1. It reduces the overall orthodontic treatment cost as the use of additional requirements like headgear, micro-implants, mini-implants and 2^{nd} molar bonding is reduced considerably in ordinary cases and used in critical situations only.
2. It reduces the treatment duration because of reduced frictional resistance and binding, so walking of canine on arch wire is faster than the conventional mechanics.

### INDUSTRIAL APPLICABILITY

The present invention is basically related to the medical industries. The arch wire of the present invention is the main accessory of the orthodontic apparatus. It provides corrective forces to the teeth so as to reposition them in a desired configuration. It can be used in Upper and lower dental arch. Also it can be used with Conventional ligation with ligature wire or elastomeric or elastic module. Further it can be used with self-ligating brackets and tooth colored esthetic brackets. The arch wire has standard dimension (16×22 mil wire in 018 slot and 19×25 mil wire in 022 slot), however larger dimension wires can be used in critical situations, wherein said larger dimension wire is either directly rounded off from its original dimension or dimension of wire at canine and 1^{st} premolar region is first reduced to the conventional standard dimension for effective sliding and then it is rounded off.

The present invention is not limited to the above described embodiments, and various alterations, modifications, and/or alternative applications of the invention may be possible, if desired, without departing from the scope and spirit of the invention which can be read from the claims and the entire specification. All these possible alterations, modifications, and/or alternative applications of the invention are also intended to be within technical scope of the present invention.

1. A five segment orthodontic arch wire to provide a track for movement of teeth for correcting misalignment of teeth, said arch wire generally having “U’ shape and having same longitudinal axis through out the length, said arch wire characterized by:
first segment having rectangular cross section and being provided for the posterior, 2^{nd} premolar and molar region in left side of the jaw;
second segment having modified rectangular cross section with rounded off corners, said second segment is followed by said first segment and provided for the canine and first premolar region in left side of the jaw;
third segment having rectangular cross section, said third segment is followed by said second segment and provided for the anterior, incisor region;
fourth segment having modified rectangular cross section with rounded off corners, said fourth segment is followed by said third segment and provided for the canine and 1^{st} premolar region in right side of the jaw; and
fifth segment having rectangular cross section, said fifth segment is followed by said fourth segment and provided for the posterior, 2^{nd} premolar and molar region in right side of the jaw, wherein said arch wire is single piece and continuous in construction.

2. The five segment orthodontic arch wire as claimed in claim 1 wherein corners of the second and fourth segments of said arch wire are rounded off with circular arc centered at the center of the rectangle and having same radius of curvature at all corners.

3. The five segment orthodontic arch wire as claimed in claim 1 wherein corners of the second and fourth segments of said arch wire are rounded off with circular arc centered at the center of the rectangle and having different radius of curvature at all corners.

4. The five segment orthodontic arch wire as claimed in claims 2 and 3 wherein corners of the second and fourth segments of said arch wire are rounded off with circular arc centered at the center of the rectangle and with radius of curvature varying in the range of about 0.25 mm to 0.40 mm.

5. The five segment orthodontic arch wire as claimed in claim 4 wherein said radius of curvature is in the range of about 0.28 mm to 0.336 mm, applicable for the arch wires in 018 slot.

6. The five segment orthodontic arch wire as claimed in claim 4 wherein said radius of curvature is in the range of about 0.32 mm to 0.365 mm, applicable for the arch wires in 022 slot.

7. The five segment orthodontic arch wire as claimed in any preceding claims wherein values of radius of curvature are selected as an effective compromise between torque expression requirement and reduction in frictional resistance and in turn anchorage requirement.

8. The five segment orthodontic arch wire as claimed in any preceding claims wherein said arch wire is made of stainless steel.

9. The five segment orthodontic arch wire as claimed in any preceding claims wherein said arch wire is made of super elastic nickel-titanium.

10. The five segment orthodontic arch wire as claimed in any preceding claims wherein said arch wire is made of tooth colored Teflon coated wire.

11. The five segment orthodontic arch wire as claimed in any preceding claims wherein said arch wire is made of Titanium Molybdenum Alloy.

12. An orthodontic apparatus for correcting misalignment of the teeth comprises:
a five segment orthodontic arch wire as claimed in claims 1 to 11; and
plurality of brackets with slots for coupling said arch wire to the teeth, said slots have shape and size as per the shape and size of said segments so that arch wire is properly fitted in said bracket slots.

13. The orthodontic apparatus as claimed in claim 12 wherein said brackets are secured to the teeth by direct adhesive attachment.

14. The orthodontic apparatus as claimed in claim 12 wherein said brackets are secured to the teeth by being fastened to a tooth band fitted over and cemented to the teeth.

15. A five segment orthodontic arch wire to provide a track for movement of teeth for correcting misalignment of teeth such as herein before described and illustrated with reference to accompanying drawings.
